(19) United States
(12) Patent Application Publication
(10) Pub. No.: US 2008/0317266 A1
(43) Pub. Date: Dec. 25, 2008

(54) Contact Structure of a Film-Type Audio-Speaker

(75) Inventors: Ju Seon Youn, Incheon-si (KR); Chang Ju Ra, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(73) Assignee: DREAM SONIC TECHNOLOGY LIMITED, Mongkok Kowloon (HK)

(21) Appl. No.: 12/064,722

(22) PCT Filed: Jan. 23, 2006
(86) PCT No.: PCT/KR2006/000254

§ 371 Date: Sep. 3, 2008

(30) Foreign Application Priority Data
Aug. 24, 2005 (KR) 10-2005-0078030

(51) Int. Cl. H04R 17/00

(52) U.S. Cl. 381/190

(57) ABSTRACT

The invention is a contact structure of a film-type audio-speaker of a structure appropriate for transmitting audio signal current to the entire audio-speaker surface without attenuating the strength of the signals while achieving enhanced durability. There is provided a contact structure for use in a film-type audio-speaker including a piezoelectric film unit having a piezoelectric film which is obtained by surface-treating a film and coating an electrically conductive polymer layer on the surface of the film, and one or more terminal portions which are electrically connected to a piezoelectric film unit, the contact structure of the film-type audio-speaker comprising: a metal electrically conductive layer coated around the circumference of the piezoelectric film unit, and having a relatively excellent electrical conductivity in comparison with the electrically conductive polymer layer, wherein the terminal portions are in close contact with the metal electrically conductive layer.

### TECHNICAL FIELD

The present invention relates to a contact structure of a film-type audio-speaker, and more particularly, to a contact structure of a film-type audio-speaker of a new structure appropriate for transmitting signal current to the entire audio-speaker surface without attenuating the strength of the signals while achieving enhanced durability.

### BACKGROUND ART

A conventional audio-speaker for an acoustic device is chiefly a cone-shaped audio-speaker including a cone-shaped structure having a vibration plate and an enclosure playing a role of a resonance chamber. Recently, a film-type audio-speaker formed of a thin and light film has been developed and introduced. The film-type audio-speaker is fabricated with a piezoelectric film. Ions or high-frequency plasma gases are applied to the piezoelectric film which process results in the transformation of the quality of the surface of the piezoelectric film. Then, an electrically conductive material is coated on the piezoelectric film. Accordingly, when an audio signal is applied to the piezoelectric film, sound is generated by vibration of the piezoelectric film. In order to apply audio signals to the film-type audio-speaker, contact terminals are attached to one side of the piezoelectric film unit.

### DISCLOSURE OF INVENTION

### Technical Problem

At present, an electrically conductive polymer having a relatively excellent vibration characteristic such as the quality and pressure of sound generated is used as an electrically conductive material which is coated onto the surface of the piezoelectric film for a film-type audio-speaker. The electrically conductive polymer is of a relatively low electrical conductivity in comparison with an electrically conductive layer made of a metallic material. Also, in order to apply an electrical signal current to an electrically conductive polymer layer in the piezoelectric film, a copper tape is attached to one side of the electrically conductive polymer layer in the piezoelectric film, and an electric wire is connected to the copper tape. However, as a piezoelectric film unit constituting a film-type audio-speaker is vibrated itself, the copper tape attached to the electrically conductive polymer layer does not maintain a sufficiently close adhesion state, but will be partially detached from each other. Accordingly, when the contact is damaged, the electrical connection will be cut off at the points of the contact, or a sufficient signal transfer cannot be accomplished via the contact even if the electrical connection is not cut off at the points of the contact. As a result, the sound generated by the film-type audio-speaker will either stop or become weak.

Also, since the contact is formed at the circumference of one side of the piezoelectric film unit in the case of the conventional film-type audio-speaker, audio signals are greatly attenuated at the inner portion of the piezoelectric film unit which is located relatively more distant from the points of contact, or attenuated at the opposing side of the points of contact. The above happens during the process of transferring signals via an electrically conductive polymer layer having a relatively large electrical resistance. As a result, a uniform and sufficient volume of sound cannot be generated over the entire surface of the piezoelectric film unit.

### Technical Solution

To solve the above problems, it is an object of the present invention to provide a contact structure of a film-type audio-speaker which comprises a new structure appropriate for transmitting the electrical signal current to the entire audio-speaker surface of the film and generating a sufficient volume of sound without attenuating the strength of the audio signal sound as well as possessing a greater durability with respect to the vibration of the film.

To accomplish the above object of the present invention, there is provided a contact structure for use in a film-type audio-speaker including a piezoelectric film unit 2 having a piezoelectric film 3 which is obtained by surface-treating a film and coating an electrically conductive polymer layer 4 on the surface of the film 3, and one or more terminal portions 6 which are electrically connected with a piezoelectric film unit 2, the contact structure of the film-type audio-speaker comprising: a metal electrically conductive layer 12 coated around the circumference of the piezoelectric film unit 2, and having a relatively excellent electrical conductivity in comparison with the electrically conductive polymer layer 4, wherein the terminal portions 6 are in sufficiently close contact with the metal electrically conductive layer 12.

According to another feature of the present invention, the metal electrically conductive layer 12 is penetrated into the inner portion of the piezoelectric film unit 2 via an inward extension portion 14 extended towards the inner portion of the piezoelectric film unit 2 from the circumference of the piezoelectric film unit 2.

According to still another feature of the present invention, the metal electrically conductive layer 12 is coated with silver.

### ADVANTAGEOUS EFFECTS

As described above, since the metal electrical conductive layer having a relatively excellent electrical conductivity is coated on the circumference of the piezoelectric film unit on which the electrically conductive polymer layer has been coated, signal current is smoothly transmitted over the entire surface of the piezoelectric film unit via the metal electrically conductive layer without being attenuated. As a result, a film-type audio-speaker having an amount of abundant sound can be obtained.

Also, since the metal electrically conductive layer is coated on the piezoelectric film unit so as to be closely adhered thereto, damage to or detachment of the points of contacts is prevented even in the case of vibration of the piezoelectric film unit, in comparison with the contact structure where the conventional copper tape has been attached, resulting in an enhanced durability.

Further, since the metal electrically conductive layer is extended into the piezoelectric film unit via the inward extension portion, electrical resistance is further minimized all over the entire surface of the piezoelectric film unit in respect of signal current being transmitted. Accordingly, a more abundant volume of sound can be obtained from the film-type audio-speaker.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a front view showing a contact structure of a film-type audio-speaker accordingly to one embodiment of the present invention;

FIG. 2 is a cross-sectional view of FIG. 1; and

FIG. 3 is a front view showing a contact structure of a film-type audio-speaker according to another embodiment of the present invention.

### BEST MODE FOR CARRYING OUT THE INVENTION

Hereinbelow, a contact structure of a film-type audio-speaker according to a preferred embodiment of the present invention will be described in detail with reference to the accompanying drawings.

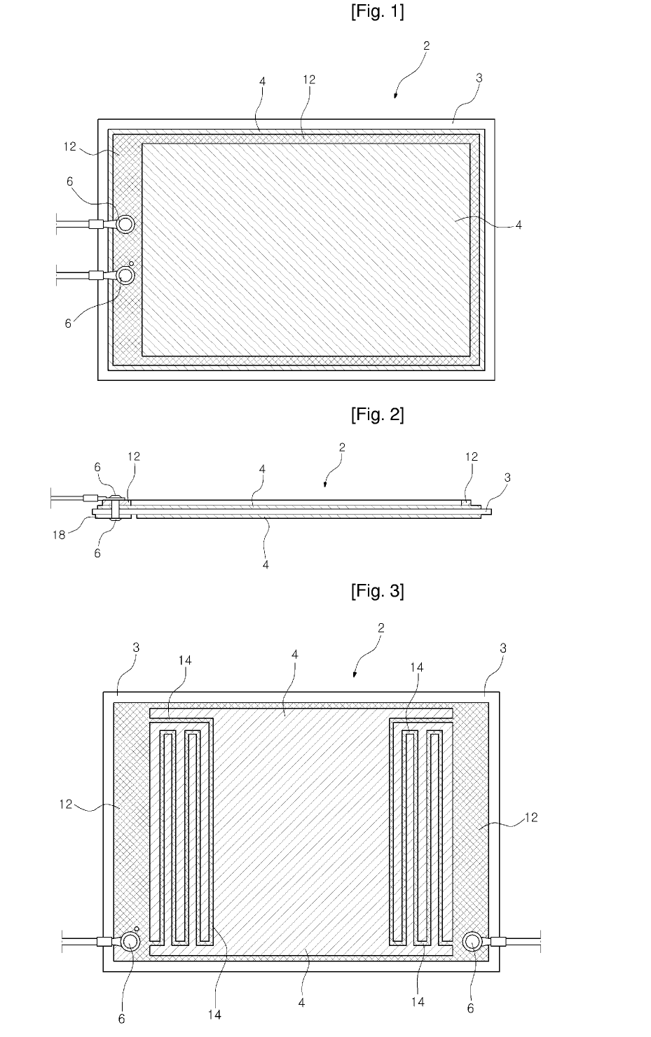

Referring to FIGS. 1 and 2, a piezoelectric film unit 2 is obtained by surface-treating a piezoelectric film 3 with ions or high-frequency plasma to result in a hydrophilic property and by coating a conductive polymer layer 4 thereon. The piezoelectric film unit 2 possesses a piezoelectric property that generates a mechanical vibration if electricity is applied thereto, and generates an electromotive force therefrom, and reversely if a mechanical deforming force is applied to the piezoelectric film unit 2. Thus, if an audio signal is applied to the piezoelectric film unit 2, the piezoelectric film is vibrated to generate sound.

Also, a metal electrically conductive layer 12 having a more excellent electrical conductivity than that of the electrically conductive polymer layer 4 is coated on the circumference of the piezoelectric film unit 2 on which the electrically conductive polymer layer 4 is coated. Preferably, silver Ag which has an excellent electrical conductivity and is relatively less costly is used as a material of the metal electrically conductive layer 12.

Ring-type terminals or rivet-shaped connection terminals 6 closely contacting the metal electrically conductive layer 12 are attached to or coupled with one side of the piezoelectric film unit 2 on which the metal electrically conductive layer 12 has been coated. Also, in order to prevent an electrical short of the contact, a reinforcement tap 18 made of polyester or other insulating materials can be provided at the place of each connection terminal under the piezoelectric film.

As described above, the metal electrically conductive layer 12 having an excellent electrical conductivity is coated along the circumference of the conductive polymer layer 4. The connection terminals 6 are connected with the metal electrically conductive layer 12. Accordingly, signal current can be applied from the circumference of the whole area of the piezoelectric film unit 2. As a result, in the case that a signal is transferred via the electrically conductive polymer layer 4 having a relatively larger electrical resistance, and a signal output from a film-type audio-speaker is prevented from being greatly attenuated or weakened at a location more distant from the connection terminals 6. Further, since the metal electrical conductive layer 12 forming contacts is coated on the piezoelectric film unit 2 so as to be closely adhered thereto, damage to or detachment of the contacts due to the vibration movement of the piezoelectric film unit 2 is prevented. Accordingly, the durability of the film-type audio-speaker is increased.

FIG. 3 is a front view showing a contact structure of a film-type audio-speaker according to another embodiment of the present invention. Referring to FIG. 3, a metal electrical conductive layer 12 which is coated on the circumference of the piezoelectric film unit 2 is extended inward and towards the centre of the piezoelectric film unit 2 while forming a predetermined pattern, to thereby constitute an inward extension portion 14. As described above, the metal conductive layer 12 is extended and penetrated into the centre of the piezoelectric film unit 2 via the inward extension portion 14. Accordingly, attenuation of the signal current flowing over the entire surface of the piezoelectric film unit 2 is further reduced. As a result, since the signal is smoothly transmitted to the entire surface of the piezoelectric film unit 2, a more abundant sound can be generated from the film-type audio-speaker. In the illustrated embodiment, the inward extension portion 14 is extended in a zigzag form. However, the inward extension portion 14 can be formed in various forms. The inward extension portion 14 can be also extended up to a sufficient depth in the inner portion of the piezoelectric film unit 2, to a degree necessary to secure a proper volume of sound.

1. A contact structure for a film-type audio-speaker including a piezoelectric film unit having a piezoelectric film which is obtained by surface-treating a film and coating an electrically conductive polymer layer on the surface of the film, and one or more terminal portions which are electrically connected with a piezoelectric film unit, characterized in that a metal electrically conductive layer which has a relatively excellent electrical conductivity in comparison with the electrically polymer layer is coated around the circumference of the piezoelectric film unit and the terminal portions are in close contact with the metal electrically conductive layer.

2. A contact structure for a film-type audio-speaker of claim 1, wherein the metal electrically conductive layer is penetrated into the inner portion of the piezoelectric film unit via an inward extension portion extended towards the inner portion of the piezoelectric film unit from the circumference of the piezoelectric film unit.

3. A contact structure for a film-type audio-speaker of claim 1 wherein, the metal electrically conductive layer is coated with silver.

4. A contact structure for a film-type audio-speaker of claim 2 wherein, the metal electrically conductive layer is coated with silver.
